(19) United States
(12) Patent Application Publication
(10) Pub. No.: US 2008/0208666 A1
(43) Pub. Date: Aug. 28, 2008

(54) Business process modeling to facilitate collaborative data submission

(75) Inventors: George Randall Dong, Issaquah, WA (US); Jeffrey A. Wang, Seattle, WA (US); Lan Chen, Bellevue, WA (US); Jin Wang, Kirkland, WA (US); Sridharan V. Ramanathan, Kirkland, WA (US); Sanjay Jacob, Redmond, WA (US); Bhaskar Bhattacharyya, Bellevue, WA (US); Patrick John Baumgartner, Pullman, WA (US); Xiaohong Yang, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/709,983

(22) Filed: Feb. 23, 2007

(51) Int. Cl. G06Q 90/00

(52) U.S. Cl. 705/8

(57) ABSTRACT

Technologies are described herein for modeling business processes that facilitate the collaborative submission of data in a WFM system by modeling business processes in terms of cycles and assignments. A cycle defines a scenario for the business process along with a window of time in which the business process should be executed. Assignments are work activities that are defined within each cycle. A cycle definition is created for each business cycle within a business process. Each cycle definition includes data defining a recurrence pattern for the business cycle and data defining a time period in which one or more contributors to the business cycle may contribute data. Each cycle definition also includes one or more assignment definitions that define the scope, contributors, approvers, validation rules, deadlines, and data forms that should be used for the assignment.

### BACKGROUND

Workflow management (“WFM”) systems are computing systems that provide functionality for modeling business processes along with the ability to implement and monitor the procedural and computational aspects of each process. For example, a corporation may utilize a WFM system to model a business process for generating a rolling forecast of sales generated by the organization. As part of the modeling process, the employees of the corporation that submit data as a part of the process are identified, as are the supervisory employees that are responsible for approving or rejecting the submitted data.

When such a model is executed by a WFM system, the system utilizes the model to manage the procedural aspects of the process. For instance, a request for the submission of data may be generated and transmitted to the employees identified by the model as being responsible for supplying the data. When the data is submitted, it is stored in a database for use in business reporting and business calculations also defined within the model. An appropriate supervisory employee may also be requested to approve the submission. For instance, in the rolling sales forecast example, one employee may be responsible for submitting sales figures for North America while another employee is responsible for submitting sales figures for Europe. These figures may then be stored in a database for use in business reporting and business calculations performed by the WFM system, such as using the figures to compute a worldwide sales figure. Appropriate supervisory employees within the organization may be required to approve the submissions. In this manner, employees of the organization can collaboratively submit data to the WFM system for use in the modeled business process.

In previous WFM systems, business processes must often be modeled based upon the structure of the organization in which the process is implemented. For instance, previous WFM systems frequently require modeling workflow based upon the structure of an organizational entity. The advantage of this approach is that it is easy to understand. However, rigidly modeled workflows based upon an organizational structure often do not represent the true flow of work within an organization. Moreover, in such previous WFM systems, it is often difficult to customize the organizational hierarchy-based model to reflect the true flow of work within the organization.

It is with respect to these considerations and others that the disclosure made herein is provided.

### SUMMARY

Technologies are described herein for modeling business processes that facilitate the collaborative submission of data in a WFM system. Through aspects presented herein, business processes can be flexibly modeled without being constrained by an organizational hierarchy. Moreover, through other aspects described herein, user data permissions are separated from the business process definition to thereby eliminate the rigidity of business process modeling found in some previous WFM systems.

According to one aspect presented herein, a business process is modeled in terms of cycles and assignments. A cycle defines a scenario for the business process and a window of time in which the business process should be executed. For instance, a recurring cycle may be defined for calculating sales figures that recurs at the beginning of each month. Assignments are work activities that are defined within each cycle. An assignment may be made to a single contributing user or a group of contributors. A set of data entry forms may also be associated with an assignment and provided to the contributors for data entry. For example, an assignment may require that a user provide a sales figure using a specified data entry form.

In order to model a cycle and its assignments within a business process, a cycle definition is created. A cycle definition is a data structure having data stored therein that defines a business cycle. In particular, according to one embodiment, a cycle definition includes data defining a recurrence pattern for the business cycle along with data defining a time period in which one or more contributors to the business cycle may contribute data. For instance, a cycle definition may include data that indicates that the cycle recurs at the beginning of each month and that the contributors may contribute data to the cycle during the third week of each month.

Each cycle definition also includes one or more assignment definitions. An assignment definition is a data structure that includes data defining an assignment within a cycle. In particular, according to one implementation, each assignment definition includes data for identifying the contributors or roles to the assignment within an organization when the assignment definition is instantiated. Each assignment definition may also include a scope specification for identifying the data that is to be submitted by the contributors as part of the assignment. Each assignment definition may further include an approval chain specification that is utilized to identify the individuals within the organization that should approve the data submission and to determine the manner in which the approval should occur.

According to other aspects, each assignment definition may further include a set of validation rules that are utilized when the assignment definition is instantiated to identify a set of validation rules for validating the data submitted by the contributors. Each assignment submission may further include data identifying a set of data entry forms that should be provided to the contributors for receiving a data submission from the contributors. A deadline specification may also be included in each assignment submission that is utilized when the assignment definition is instantiated to identify a deadline by which the data submission must be received from the contributors. Other data defining an assignment may also be included in each assignment definition.

When a business cycle is instantiated, the corresponding cycle definition is utilized to create a cycle instance, including the creation of assignment instances using the assignment definitions within the cycle definition. In particular, the data stored within each assignment definition is utilized to identify the individual contributors, scope, approval chain, validation rules, data entry forms, and deadlines for each assignment. This information is stored in an assignment instance. Because assignments belong to cycles, different instances of the same assignment are created for different cycles. In this manner, the same assignment may exist concurrently in multiple cycles. The information stored in the assignment instance is utilized to provide the appropriate data entry forms to the contributors for the assignment. The contributors, in turn, utilize the provided data entry forms to submit the data required for the assignment.

According to other aspects, an application programming interface (“API”) is provided for interacting with an assignment instance. In particular, in one implementation, the API exposes a method for identifying actions that may be performed on a specified assignment instance by a specified user at the time a call to the method is made. The API may further expose another method for actually performing one of the identified actions on the assignment instance.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing an illustrative network computing architecture utilized in one embodiment described herein;

FIG. 2 is a software architecture diagram showing an illustrative software architecture for implementing a WFM system in one implementation described herein;

FIG. 3 is a data structure diagram showing the format of a cycle definition data structure and an assignment definition data structure utilized in one implementation described herein;

FIG. 4 is a software architecture diagram illustrating aspects of an API described herein for determining the actions that may be performed on an assignment instance and for performing an available action on an assignment instance in an illustrative WFM system provided herein;

FIGS. 5-6 are flow diagrams showing aspects of the operation of a WFM system in one implementation described herein; and

FIG. 7 is a computer architecture diagram showing an illustrative hardware architecture suitable for implementing the computing systems described with reference to FIGS. 1-6.

### DETAILED DESCRIPTION

The following detailed description is directed to technologies for modeling business processes that facilitate collaborative data submission within a WFM system. As will be discussed in greater detail below, utilizing aspects of the disclosure provided herein, business processes can be flexibly modeled and instantiated based upon the requirements of the business processes, rather than based upon the hierarchy of the organization in which the business processes are performed. This allows greater flexibility in the modeling of business processes than found in previous WFM systems.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

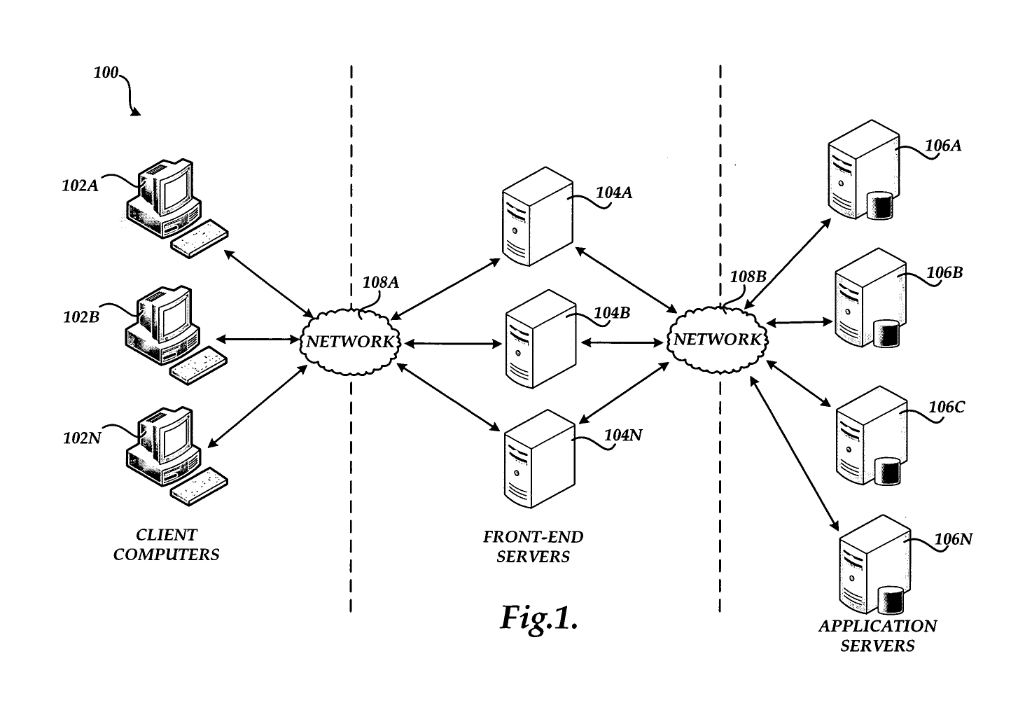

In the following detailed description, references are made to the accompanying drawings that form a part hereof, and which are shown by way of illustration specific embodiments or examples. Referring now to the drawings, in which like numerals represent like elements through the several figures, aspects of a WFM system for embodying the various aspects presented herein will be described. In particular, FIG. 1 is a network diagram showing an illustrative network computing architecture 100 that may be utilized as an operating environment for an implementation of a WFM system presented herein.

The illustrative network computing architecture 100 shown in FIG. 1 is a multi-tiered network architecture. In particular, a first tier includes the client computers 102A-102N. The client computers 102A-102N are general-purpose desktop or laptop computers capable of connecting to the network 108A and communicating with the front-end servers 104A-104N. The client computers 102A-102N are also equipped with application software that may be utilized to receive information from a WFM system and to submit data thereto. For instance, according to embodiments, the client computers 102A-102N include an electronic mail (“e-mail”) application program and a Web browser application program for receiving e-mail from a WFM system and for viewing and interacting with a Web site provided by a WFM system, respectively. The client computers 102A-102N may also include a spreadsheet application program for generating data for submission to a WFM system. It should be appreciated that the client computers 102A-102N may include other types of application software for interacting with a WFM system, for viewing data received from a WFM system, and for creating data for submission to a WFM system.

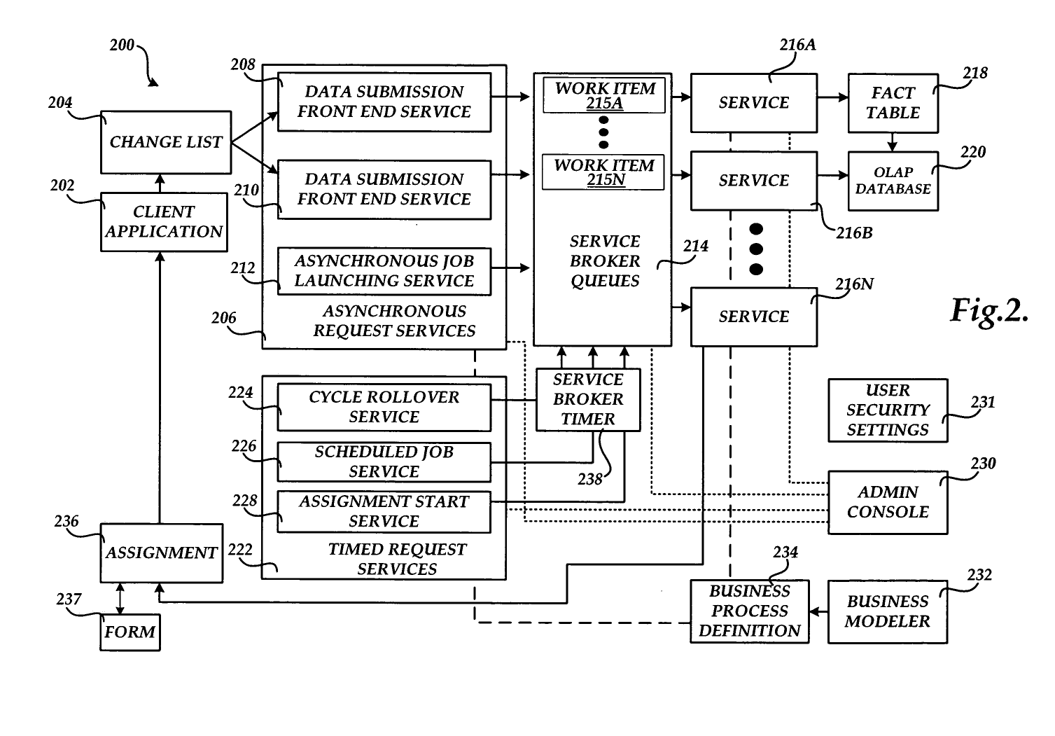

The second tier of the network computing architecture 100 shown in FIG. 1 includes the front-end servers 104A-104N. The front-end servers 104A-104N are general-purpose server computers operative to connect to the networks 108A and 108B, and to communicate with the client computers 102A-102N and the application servers 106A-106N via these networks. As will be described in greater detail below, the front-end servers 104A-104N are also operative to execute software services utilized in the provision of a WFM system. For example, the front-end servers 104A-104N may execute a data submission front-end service that is operative to receive work items in the form of data submissions from the client computers 102A-102N, and to queue the work items for processing by other services. The other services executing on the front-end servers 104A-104N are described in greater detail below with respect to FIG. 2.

The third tier of the network computing architecture 100 shown in FIG. 1 includes the application servers 106A-106N. The application servers 106A-106N are connected to the network 108B and are operative to communicate with the front-end servers 104A-104N thereby. The application servers 106A-106N are also operative to execute application programs and other back-end services for use in a WMF system. For instance, as will be described in greater detail below, the application servers 106A-106N may execute services for de-queuing and processing work items in the WMF system.

Applications may also be executed on the application servers 106A-106N. For instance, a relational database application program may be executed on the application servers 106A-106N for providing functionality for storing and querying data related to business processes executing within the WMF system. Additional details regarding the software components executing on the application servers 106A-106N will be described in greater detail below.

It should be appreciated that while FIG. 1 shows three client computers 102A-102N, three front-end servers 104A-104N, and four application servers 106A-106N, virtually any number of these computer systems may be utilized. In particular, the execution of the software components described below with respect to FIG. 2 may be distributed across any number of front-end servers 104A-104N and application servers 106A-106N. Alternatively, the software components may be executed as threads on a single server computer. The network computing architecture 100 shown in FIG. 1 may also be scaled by adding additional front-end servers 104A-104N or application servers 106A-106N as required to maintain performant operation of the system. The software components described herein are capable of scaling from execution on one to many server computer systems.

FIG. 2 is a software architecture diagram showing an illustrative software architecture 200 for implementing a WFM system in one embodiment presented herein. The software architecture 200 may be utilized to provide a high-performance scalable WFM system. As discussed briefly above with respect to FIG. 1, the software components shown in FIG. 2 and described below may be scaled onto more or fewer server computers than shown in order to provide a desired level of performance for the WFM system.

The exemplary WFM system illustrated in FIG. 2 includes a business modeler application program 232. The business modeler application program 232 provides functionality for creating a business process definition 234. The business process definition 234 contains metadata that describes a business process, including its procedural and computational aspects, timing, participants, and other data. The business process definition 234 is utilized by the various software components shown in FIG. 2 to generate assignments to participants in the business process, to obtain approval for data submitted by participants, to perform business calculations and reporting, and to otherwise facilitate implementation of the modeled business process. Although only a single business process definition 234 is illustrated in FIG. 2, it should be appreciated that many business process definitions may be utilized concurrently and that the software architecture 200 is capable of simultaneously executing multiple business processes.

The metadata contained in the business process definition 234 defines the procedural aspects of a business process in terms of cycles and assignments. A cycle defines the scenario for the business process and the window of time in which the business process should be executed. Cycles may be defined as occurring one time only or as recurrent cycles. For instance, a recurring cycle may be defined for calculating sales figures that recurs at the beginning of each month. A cycle may be locked, unlocked, opened, or closed independently of other cycles.

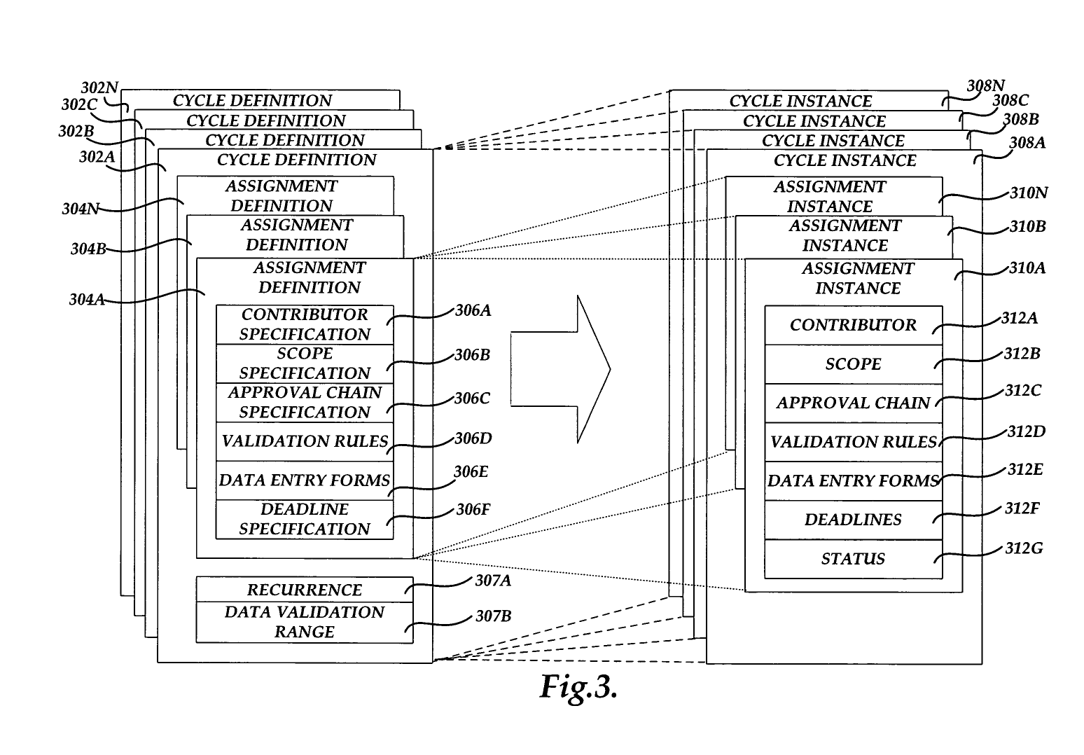

Assignments are work activities that are defined within each cycle. An assignment may be made to a single user or a group of users. A set of data entry form may also be associated with an assignment. For example, an assignment may require that a user provide a sales figure using a specified data entry form. Because assignments belong to cycles, different instances of the same assignment are created for different cycles. In this manner, the same assignment may exist concurrently in multiple cycles. Assignments may also contain properties specifying an approval chain or other validation rules that a data submission associated with the assignment must pass through for the assignment to be completed. Additional details regarding the definition of cycles and assignments within the WFM system shown in FIG. 2 will be provided below with respect to FIG. 3.

Jobs may also be generated by services executing within the WFM system as part of a cycle or assignment. For instance, a scheduled job service 226 may execute within the WFM system for launching jobs according to a schedule. As an example, the scheduled job service 226 may launch a job for generating a report according to a schedule set forth in the business process definition 234. Another job may be periodically instantiated for reprocessing the contents of a database, such as the online analytical processing (“OLAP”) database 220.

Cycles, assignments, and jobs may generate work items 215 in conjunction with their execution. Work items 215 are tasks that must be performed as a part of the execution of a cycle, assignment, or job within a modeled business process. For instance, a work item 215 may constitute a database writeback operation performed in response to the submission of data to the WFM system by a user. In order to remain responsive to user submissions, the WFM system must process work items 215 in an efficient manner. If work items 215 cannot be processed efficiently, an undesirable delay may be imposed upon users of the WFM system during data submission.

In order to process work items 215 in an efficient manner, the WFM system illustrated in FIG. 2 utilizes one or more service broker queues 214. The service broker queues 214 are first-in/first-out (“FIFO”) queues or priority queues that may be utilized by services executing within the WFM system to hold work items 215. In the illustrative architecture shown in FIG. 2, several types of services may queue work items 215 on the service broker queues 214. In particular, asynchronous request services 206 and timed request services 222 can place work items 215 on the queues 214. In the case of the three-tiered network architecture shown in FIG. 1, these queues are maintained at the front-end servers 104A-104N. Alternatively, these queues may be maintained at the application servers 106A-106N. These queues may also be maintained at another computing system specifically dedicated to storing the queues. It should be appreciated that the WFM system illustrated in FIG. 2 is merely illustrative, provides but one operating environment for the embodiments presented herein, and that the various aspects described herein may be utilized with many different types of WFM systems other than the one shown in FIG. 2.

The asynchronous request services 206 place work items 215 on the queues 214 asynchronously, and include the data submission front-end services 208A-208B and the asynchronous job launching service 212. The data submission front-end services 208A-208B receive data submissions from client applications and place appropriate work items 215 for the submitted data on the queues 214. The number of data submission front-end services 208A-208B may be scaled to handle a large number of client data submissions and other types of client requests such as reporting or what-if analysis. The asynchronous job launching service 212 is utilized to asynchronously place work items 215 on the queues 214 corresponding to system jobs.

The timed request services 222 place work items 215 on the queues 214 according to a time schedule. For instance, the cycle rollover service 224 is responsible for creating a new instance of a cycle according to a recurrence pattern defined within the cycle. In a similar fashion, the assignment start service 228 is responsible for instantiating new scheduled assignments. The scheduled job service 226 is responsible for instantiating jobs according to a specified time schedule. For instance, the scheduled job service 226 may queue work items for performing business calculations or performing outbound recording. Each of the services 224, 226, and 228, place the appropriate work items 215 on the queues 214 using the service broker timer 238. The service broker timer 238 ensures that the work items 215 are placed on the appropriate queue at the appropriate time. Because work items 215 are placed on the queues 214, rather than being directly consumed by back-end services, a high level of responsiveness to client applications can be maintained. It should be appreciated that the events and jobs executing within the WFM system presented herein may have a cascading effect that triggers the execution of other events and jobs. For instance, the execution of a cycle may start a work item that instantiates various jobs and assignments. The jobs and assignments, in turn, may set and queue timed events for other jobs and assignments to begin. It should be appreciated that many cycles, work items, assignments, and jobs may trigger other objects in a similar manner.

The work items 215 placed on the queues 214 are de-queued and processed by other services executing within the WFM system. In particular, the services 216A-216N (which may be referred to herein as back-end services) are responsible for de-queuing work items 215, validating the work items 215, and performing processing as indicated by the work items 215. The services 216A-216N de-queue work items 215 as computational capabilities are made available. Moreover, the services 216A-216N can scale to multiple computing systems, thereby providing flexibility to add new hardware to the WFM system shown in FIG. 2 to increase performance.

To illustrate the use of the queues 214, the generation and processing of an illustrative data submission assignment 236 will now be described. In this example, a business process definition 234 indicates that the assignment 236 should be instantiated as part of a cycle. The cycle rollover service 224 is responsible for instantiating the cycle and the assignment start service 228 is responsible for instantiating the assignment 236. Once the assignment 236 has been instantiated, the assignment 236 is provided to a user of the WFM system. As mentioned briefly above, an e-mail client application, a Web browser application, or another type of application program capable of displaying the assignment 236 to a user may be utilized to view the assignment 236. According to aspects, the assignment may include a data form 237 that is utilized by the client application 202 to provide the data required by the assignment. For instance, in an embodiment, the data form 237 may comprise a Web form in which a contributor can provide the requested data submission. The data form 237 may also take the form of a spreadsheet or workbook.

In response to receiving the assignment 236, a user may generate data that should be stored in the fact table 218 and the OLAP database 220. For instance, a user may utilize a client application 202, such as a spreadsheet application program, to generate the requested data. In one implementation, this data is represented as an extensible markup language (“XML”) change list 204 that includes data describing how the generated data should be stored within the fact table 218 and the OLAP database 220. It should be appreciated, however, that the change list 204 may comprise any type of package or document format. It may also be compressed and/or encrypted to allow more efficient and secure network transmission. It should also be appreciated that, in addition to the change list 204, the client application 202 may also submit one or more documents that support the contents of the change list 204. For instance, a spreadsheet document that includes the underlying computations utilized to arrive at the contents of the change list 204 may be submitted. A back-end service executing within the WFM system can verify the contents of the supporting documents and store the documents in an appropriate database or document library within the WFM system.

When the user submits the data requested in the assignment 236 to the WFM system through the data form 237, the change list 204 is received by one of the data submission front-end services 208A-208B. In response thereto, the front-end service that receives the change list 204 places a database writeback work item 215 on the service broker queues 214 indicating that the change list 204 should be applied to the OLAP database 220. The appropriate service 216A de-queues the database writeback work item 215 from the queues 214 and processes the work item 215. In this example, the service 216A makes the appropriate change in the fact table 218. Another service 216B may be executed by the scheduled job service 226 for periodically reprocessing the contents of the fact table 218 into the OLAP database 220.

According to embodiments, the software architecture 200 also includes an administrative console application program 232. The administrative console application program 230 communicates with the various services and software components described above to control the state of operation of the WFM system embodied by the software architecture 200. For instance, a system administrator may utilize the administrative console application program 232 to place the WFM system online or to lock the operation of the WFM system.

As also shown in FIG. 2, global user security settings 231 may also be maintained within the WFM system. The security settings 231 define the set of data within the WFM system that each user has privileges to read or write. For instance, in one implementation, the security settings 231 specify the dimensions or elements within the OLAP database 220 that each user is authorized to read or write. The security settings 231 are centrally stored, and maintained separate and apart from any business process, organizational hierarchy, or workflow definition.

As will be described in greater detail below, when a user is given the privilege of submitting data in a cycle, the security settings 231 are utilized to determine whether the user is authorized to submit the requested data. If the user is not authorized to submit the data, as specified by the security settings 231, the user will not be permitted to submit data in the cycle. Separating the security settings for each user from the business process definition provides a great deal of flexibility in modeling a business process as described herein. For instance, in other implementations where security settings are specified within assignments, many assignments may need to be altered in the event that the privileges for one user need to be modified. Additional details regarding the use of the security settings 231 are provided below.

FIG. 3 is a data structure diagram showing additional details regarding the business process definition 234 discussed briefly above with respect to FIG. 2. In particular, in one embodiment, the business process definition 234 includes one or more cycle definitions 302A-302N. Each of the cycle definitions 302A-302N is a data structure having data stored therein that defines a business cycle. In particular, according to one embodiment, each cycle definition 302A-302N includes a data field 307A for storing data identifying a recurrence pattern for the business cycle. The recurrence pattern defines when the business cycle should recur. According to implementations, each of the cycle definitions 302A-302N may also include a data field 307B for storing a data validation range. The data validation range defines the time period in which one or more contributors to the business cycle may contribute data to the cycle. Contributors are not permitted to submit data to the cycle outside of the specified time period.

As also shown in FIG. 3, each of the cycle definitions 302A-302N includes one or more assignment definitions 304A-304N. The assignment definitions 304A-304N include data that may be utilized to define the scope, contributors, approvers, validation rules, deadlines, and data entry forms that should be used for the assignment. For example, in one implementation, the assignment definition 304A includes a data field 306A for storing data identifying the contributors to the assignment within an organization. The data stored in the data field 306A may specifically identify the contributors to the assignment or may include data from which the contributors can be determined when the assignment is instantiated in the manner described below.

The assignment definition 304A shown in FIG. 3 also includes a data field 306B for storing data identifying a scope specification. A scope specification identifies the particular data that is to be submitted by the contributors as part of the assignment. For instance, the scope specification may identify particular dimensions or data elements within the OLAP database 220. In one embodiment, the scope is determined from the security settings 231 for the contributors. The assignment definition 304A may further include a data field 306C for storing data identifying an approval chain specification that is utilized to identify the individuals within the organization that should approve the data submission and to determine the manner in which the approval should occur.

According to other aspects, the assignment definition 304A also includes a data field 306D for storing data identifying a set of validation rules for the assignment. A set of validation rules are utilized to validate the data submitted by the contributors. The assignment definition 304A also includes a data field 306E for storing data identifying the data entry forms 237 that should be provided to the contributors for submitting data in the assignment. A field 306F may also be included in the assignment definition 304A for specifying a deadline specification that identifies a deadline by which the data submission must be received from the contributors. In other implementations, other data defining aspects of an assignment may also be included in each assignment definition.

When a business cycle is instantiated by the WFM system, the appropriate cycle definition 302 is utilized to create a cycle instance 308, including the creation of assignment instances 310 using the assignment definitions 304 within the cycle definition 302. For instance, when the cycle definition 302A is instantiated as the cycle instance 308A, the assignment instances 310A-310N are created corresponding to the assignment definitions 304A-304N. When each assignment is instantiated, the data stored within the data fields of each assignment definition is utilized to identify the actual contributors, scope, approval chain, validation rules, data entry forms, and deadlines for each assignment. This information is then stored in the appropriate assignment instance. For example, the data stored in the fields 306A-306F of the assignment definition 304A is utilized to populate the fields 312A-312F of the assignment instance 310A. The assignment instance 310A also includes a data field 312G for storing data indicating the status of the assignment instance (e.g. submitted, approved, rejected, etc.).

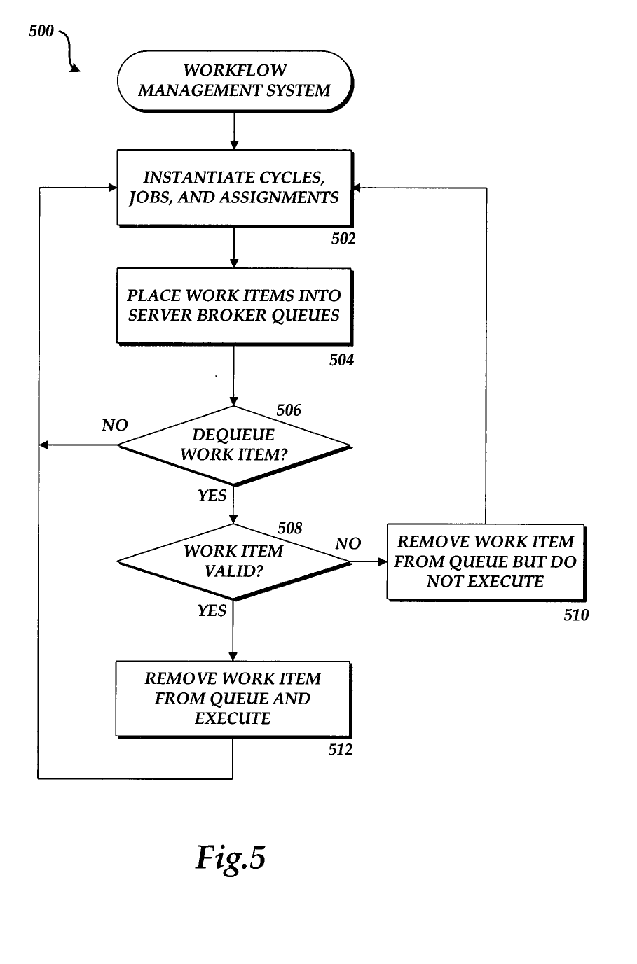

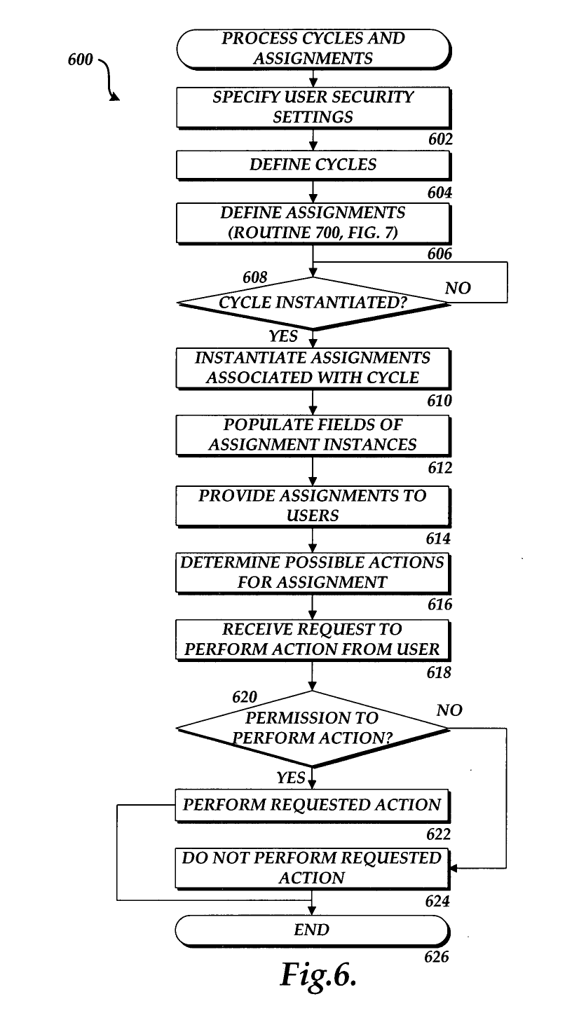

As discussed above, once an assignment has been instantiated, the information stored in the fields 312A-312F of the assignment instance is utilized to provide the appropriate data entry forms 237 to the contributors for the assignment. The contributors, in turn, utilize the provided data entry forms 237 to submit the data required for the assignment. If specified, validation rules may be utilized to validate the submitted data and an approval chain may be utilized to obtain the necessary approvals for the submitted data. The submitted data will also be rejected if it is submitted outside of the time frame specified by the deadline specification or the data validation range, both of which are described above. Additional details regarding this process are provided below with respect to FIGS. 5-6.

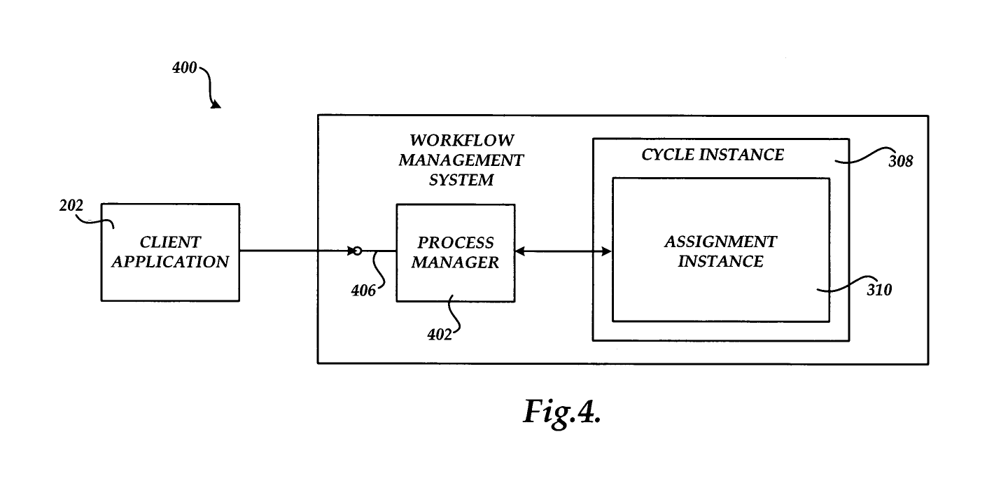

FIG. 4 is a software architecture diagram illustrating aspects of an API 406 described herein for determining the actions that may be performed on an assignment instance 310 and for performing an available action on an assignment instance 310 in an illustrative WFM system provided herein. In particular, as shown in FIG. 4, a process manager 402 executes within the WFM system to coordinate various aspects of the operation of the software components described above with respect to FIG. 2. In one implementation, the process manager 402 exposes an API 406 to client applications 102 utilized within the WFM system.

The API 406 provides for functionality for interacting with an assignment instance 310 within a cycle instance 308. In particular, in one implementation, the API 406 exposes a method for identifying actions that may be performed on a specified assignment instance 310 by a specified user at the time a call to the method is made. The API 406 may further expose another method which, when called, will cause one of the available actions for the assignment instance 310 to be performed.

As discussed above, assignments instances can be created dynamically. Assignment instances can also be created on demand or on an ad hoc basis. Similar assignments on consecutive cycles can be maintained at the same time without conflicting. The behavior of an assignment depends upon the properties of the assignment described above (e.g. status, type, approval chain, etc.), the cycle the assignment belongs to, and the role a particular user plays in the assignment. Since the actions that may be performed on an assignment is not predetermined, the API 406 dynamically determines the available actions for an assignment instance 310 at the time a call to the API 406 is made. After the appropriate actions have been determined using the API 406, a second call can be made to the API 406 to dispatch one of the available actions. In a similar manner, the API 406 may expose methods for determining the actions that can be performed by a particular user on a cycle instance 308 at a particular time, and for performing one of the available actions on the cycle instance 308.

Referring now to FIG. 5, additional details will be provided regarding the operation of an illustrative WFM system described herein. In particular, FIG. 5 is a flow diagram showing a routine 500 that illustrates the general operation of the WFM system described above with reference to FIGS. 1-4. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in FIG. 5 and described herein. These operations may also be performed in a different order than those described herein with respect to FIG. 5.

The routine 500 begins at operation 502, where cycles, assignments, and jobs are instantiated by the WFM system in the manner described above. As discussed above, the cycles, assignments, and jobs are defined by the business process definition 234 and instantiated by the various services executing within the WFM system, such as the cycle rollover service 224 and the assignment start service 228. Once the appropriate cycles, assignments, and jobs have been instantiated, the routine 500 continues to operation 504.

At operation 504, work items are placed onto the service broker queues 214 by the cycles, assignments, and jobs. For instance, as described above, a user data submission may result in a work item 215 being placed on the service broker queues 214 by one of the data submission front-end services 208A-208B. Other services may place work items on the service broker queues 214 in a similar manner. From operation 504, the routine 500 continues to operation 506, where queue monitors determine if work items 215 are present in the queues 214 that should be de-queued. If no work items 215 are present for de-queuing, the routine 500 returns to operation 502 where additional assignments and jobs may be instantiated. If work items 215 are present in the queues 214 for de-queuing, the routine 500 proceeds from operation 506 to operation 508.

At operation 508, a determination is made as to whether the de-queued work item 215 is valid. If the work item 215 is invalid, the routine 500 proceeds to operation 510 where the work item is de-queued, but not processed. An error handling mechanism may be implemented to take appropriate actions if the work item is not valid. If the work item 215 is valid, the routine 500 continues from operation 508 to operation 512, where the de-queued work item is processed. For instance, in the case of a work item corresponding to a user data submission, the service 216A may write the submitted data to the fact table 218. From operations 510 and 512, the routine 500 returns to operation 502, described above.

Turning now to FIG. 6, a routine 600 will be described for processing cycles and assignments in an illustrative WFM system. The routine 600 begins at operation 602, where the security settings 231 are specified. As discussed above, the security settings 231 are globally available and are defined without respect to any particular business model or process. Once the security settings 231 have been defined and stored, the routine 600 continues to operation 604, where the cycles to be executed within the model are defined. As discussed above, the cycle definitions 302 contain data defining the cycles to be executed within the business process. The assignments to be generated within each cycle are also defined at operation 606.

According to one implementation, the contributors and approvers within an assignment may be specified using a pre-defined hierarchy, which may mirror an organizational hierarchy. When a user selects a pre-defined hierarchy, the fields of the assignment definition are populated to follow the structure of the hierarchy. The user can then edit the assignments made by the hierarchy to customize the assignment definition. In this manner, all of the benefits of using an organizational hierarchy are maintained while still retaining the flexibility to create assignments outside of an organizational structure.

Once the cycles and assignments have been defined for the business process, the routine 600 continues to operation 608, where a determination is made as to whether a cycle should be instantiated. As described above, cycles may be instantiated dynamically or on demand. If a cycle is to be instantiated, the routine 600 continues to operation 610, where assignment instances 310 are generated for each of the assignment definitions 304 in the cycle. The routine 600 then continues to operation 612, where the fields 312 of each assignment instance 310 are populated. In this manner, the contributors, scope, approval chain, validation rules, and other information is specified within each assignment instance 310.

From operation 612, the routine 600 continues to operation 614, where the data entry forms 237 is provided to each of the contributors for the assignment. The routine 600 then proceeds to operation 616, where a client application 102 may utilize the API 406 to determine the available actions for an assignment instance 310. At operation 618, a request is received to perform one of the available actions. For instance, a user may request to submit data for the assignment. In response to such a request, the routine 600 continues to operation 622 where a determination is made as to whether the user has permission to perform the requested action. This determination is based on the security settings 231. If the user has permission to perform the requested action, the routine 600 proceeds to operation 622 where the API 406 is called to perform the action. If the user does not have permission to perform the action, the routine 600 proceeds to operation 624. From operations 622 and 624, the routine 600 continues to operation 626, where it ends.

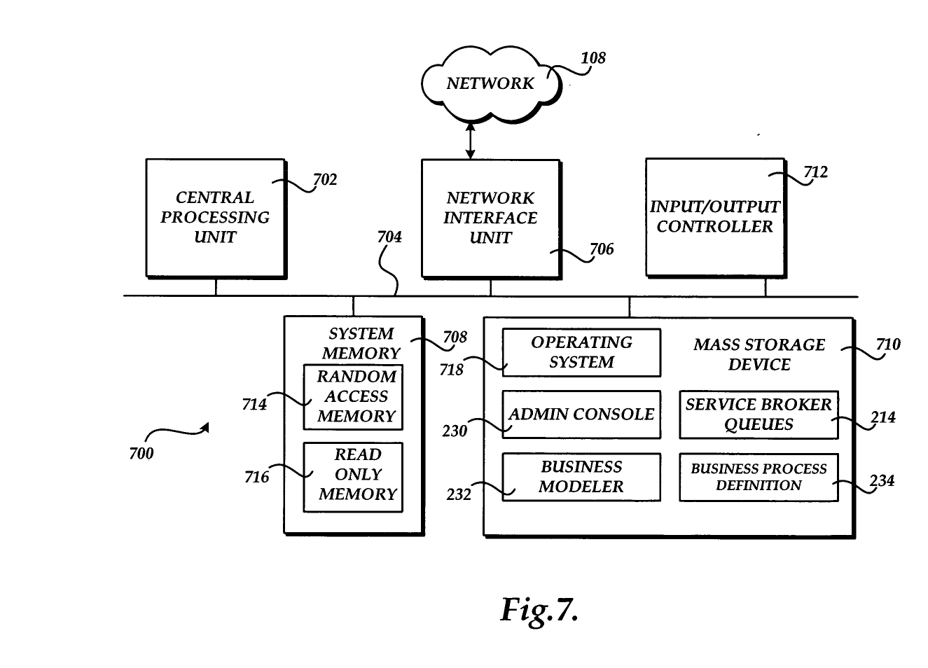

Referring now to FIG. 7, an illustrative computer architecture for a computer 700 capable of executing the software components described above with respect to FIGS. 1-6 will be discussed. The computer architecture shown in FIG. 7 illustrates a conventional desktop, laptop computer, or server computer. The computer architecture shown in FIG. 7 includes one or more central processing units 702 (“CPU”), a system memory 708, including a random access memory 714 (“RAM”) and a read-only memory (“ROM”) 716, and a system bus 704 that couples the memory to the CPU 702. A basic input/output system containing the basic routines that help to transfer information between elements within the computer 700, such as during startup, is stored in the ROM 716. The computer 700 further includes a mass storage device 710 for storing an operating system 718, application programs, and other program modules, which will be described in greater detail below.

The mass storage device 710 is connected to the CPU 702 through a mass storage controller (not shown) connected to the bus 704. The mass storage device 710 and its associated computer-readable media provide non-volatile storage for the computer 700. Although the description of computer-readable media contained herein refers to a mass storage device, such as a hard disk or CD-ROM drive, it should be appreciated by those skilled in the art that computer-readable media can be any available media that can be accessed by the computer 700.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network such as the network 108. The computer 700 may connect to the network 108 through a network interface unit 706 connected to the bus 704. It should be appreciated that the network interface unit 706 may also be utilized to connect to other types of networks and remote computer systems. The computer 700 may also include an input/output controller 712 for receiving and processing input from a number of other devices, including a keyboard, mouse, or electronic stylus (not shown in FIG. 7). Similarly, an input/output controller may provide output to a display screen, a printer, or other type of output device (also not shown in FIG. 7).

As mentioned briefly above, a number of program modules and data files may be stored in the mass storage device 710 and RAM 714 of the computer 700, including an operating system suitable for controlling the operation of a networked desktop, laptop, or server computer. The mass storage device 710 and RAM 714 may also store one or more program modules. In particular, the mass storage device 710 and the RAM 714 may store the business modeler 232, the business process definition 234, the service broker queues 214, and the administrative console application program 230, each of which has been described above with reference to FIG. 2. Other program modules may also be stored in the mass storage device 710 and utilized by the computer 700.

Based on the foregoing, it should be appreciated that technologies for modeling business processes that facilitate the collaborative submission of data in a WFM system are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for modeling a business process to facilitate collaborative data submission within a workflow management system, the method comprising:
storing a cycle definition that defines a business cycle, the cycle definition comprising one or more assignment definitions;
instantiating one or more assignment instances using the assignment definitions;
providing data entry forms associated with the assignment instances to one or more contributors; and
receiving a data submission from the contributors via the data entry forms.

2. The method of claim 1, wherein each assignment definition comprises data identifying a contributor specification that is utilized when the assignment definition is instantiated to identify the one or more contributors.

3. The method of claim 1, wherein each assignment definition comprises data identifying a scope specification that is utilized when the assignment definition is instantiated to identify the data submission that is to be received from the contributors.

4. The method of claim 1, wherein each assignment definition comprises data identifying an approval chain specification that is utilized when the assignment definition is instantiated to identify one or more approvers for approving the data submission received from the contributors.

5. The method of claim 1, wherein each assignment definition comprises data identifying a set of validation rules that are utilized when the assignment definition is instantiated to identify validation rules for validating the data submission received from the contributors.

6. The method of claim 1, wherein each assignment definition comprises data identifying a set of data entry forms for receiving the data submission from the contributors.

7. The method of claim 1, wherein each assignment definition comprises data identifying a deadline specification that is utilized when the assignment definition is instantiated to identify a deadline by which the data submission must be received from the contributors.

8. The method of claim 1, wherein the cycle definition comprises data defining a recurrence pattern for the business cycle.

9. The method of claim 1, wherein the cycle definition comprises data defining a time period in which the contributors may submit data for the business cycle.

10. A computer-readable medium having computer-executable instructions stored thereon which, when executed by a computer, cause the computer to perform the method of claim 1.

11. A method for interacting with an assignment instance in a workflow management system, the method comprising:
exposing an application programming interface (API) for interacting with an assignment instance in a workflow management system, the API exposing a first method for identifying actions that may be performed on a specified assignment instance by a specified user when a call to the first method is made.

12. The method of claim 11, wherein the API further exposes a second method for performing one of the actions on the assignment instance.

13. A computer-readable medium having computer-executable instructions stored thereon which, when executed by a computer, cause the computer to perform the method of claim 12.

14. A computer-readable medium having data fields stored therein for use in modeling a business process in a workflow management system, the computer-readable medium having stored thereon:
a first data field for storing a business cycle definition, the business cycle definition comprising data defining a business cycle within a workflow management system; and
a second data field for storing an assignment definition associated with the business cycle definition, the assignment definition comprising data defining an assignment within the business cycle.

15. The computer-readable medium of claim 14, wherein the assignment definition comprises data defining a scope for the assignment.

16. The computer-readable medium of claim 15, wherein the assignment definition further comprises data defining one or more contributors for the assignment.

17. The computer-readable medium of claim 16, wherein the assignment definition further comprises data defining an approval chain for the assignment.

18. The computer-readable medium of claim 17, wherein the assignment definition further comprises data defining a data form associated with the assignment.

19. The computer-readable medium of claim 18, wherein the assignment definition further comprises data defining a validation rule for the assignment.

20. The computer-readable medium of claim 19, wherein the assignment definition further comprises data defining a deadline specification for the assignment.
